(19) United States
(12) Patent Application Publication
(10) Pub. No.: US 2024/0309256 A1
(43) Pub. Date: Sep. 19, 2024

(54) POLYURETHANE PHASE-CHANGE NANOCAPSULE, PHASE-CHANGE POLYURETHANE POURING SEALANT AND PREPARATION METHOD THEREFOR

(71) Applicants: GUANGZHOU BAIYUN TECHNOLOGY CO., LTD., Guangdong (CN); GUANGDONG BAIYUN TECHNOLOGY CO., LTD., Guangdong (CN)

(72) Inventors: JUN SONG, Guangdong (CN); ZHI YU, Guangdong (CN); YOU RAO, Guangdong (CN); JIANJUN CHEN, Guangdong (CN); HENGCHAO HUANG, Guangdong (CN); MINGSONG MIAO, Guangdong (CN)

(73) Assignees: GUANGZHOU BAIYUN TECHNOLOGY CO., LTD., Guangdong (CN); GUANGDONG BAIYUN TECHNOLOGY CO., LTD., Guangdong (CN)

(21) Appl. No.: 18/669,429

(22) Filed: May 20, 2024

Related U.S. Application Data
(63) Continuation of application No. PCT/CN2021/132473, filed on Nov. 23, 2021.

(51) Int. Cl. C09K 5/06; B01J 13/16; C09J 11/04; C09J 11/06; C09J 11/08; C09J 175/08; C09K 5/14

(52) U.S. Cl. CPC C09K 5/063; B01J 13/16; C09J 11/04; C09J 11/06; C09J 11/08; C09J 175/08; C09K 5/14

(57) ABSTRACT

Provided are a polyurethane phase-change nanocapsule, a phase-change polyurethane pouring sealant and a preparation method therefor. The polyurethane phase-change nanocapsule is a nanocapsule formed by coating a phase-change material with an amphiphilic block copolymer. The oleophilic end of the amphiphilic block copolymer is a polyurethane chain segment, and the hydrophilic end is a methoxy polyethylene glycol chain segment. The polyurethane phase-change nanocapsule is added, such that the two-component phase-change polyurethane pouring sealant has a temperature control advantage, and has an excellent enthalpy value and heat-conducting properties while maintaining a low viscosity. In the field of electronic engineering, particularly in the field of electronics needing temperature control, the pouring sealant has an application value.

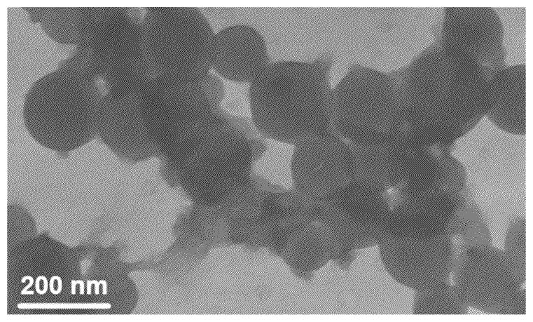

### CROSS-REFERENCE TO RELATED APPLICATION

This application is a continuation of international application of PCT application serial no. PCT/CN2021/132473, filed on Nov. 23, 2021. The entirety of the above-mentioned patent application is hereby incorporated by reference herein and made a part of this specification.

### BACKGROUND

### Technical Field

The present disclosure relates to the field of adhesive technology, in particular to polyurethane phase-change nanocapsule, phase-change polyurethane pouring sealant and a preparation method therefor.

### Description of Related Art

Phase-change materials (PCM) emerged in the 1970s due to the demand for aerospace. It is a material that can achieve temperature control by storing and converting thermal energy through conversion between different phases. According to material properties, it can be divided into inorganic phase-change materials and organic phase-change materials; according to the phase-change morphology, it can be divided into solid-liquid phase-change materials, solid-solid phase-change materials, and solid-vapor phase-change materials.

Organic phase-change materials have the advantages of high energy storage density, good thermal stability, and long cycle life, making them a hot research topic in phase-change materials. However, unlike the traditional polyurethane composite phase-change materials, phase-change polyurethane pouring sealant not only needs to have the characteristics of phase-change materials with high phase change enthalpy and strong cycle life, but also needs to have properties of good leveling, good waterproofing, and good insulation. Especially with the development of electronic products, the demand for thermal conductivity is increasing. Developing phase-change polyurethane adhesives with high enthalpy and high thermal conductivity is of great significance in response to the development trend of the electronics industry.

Phase-change microcapsule technology has been a hot research field in the field of phase-change materials in recent years. Usually, phase-change materials are melted and dispersed into droplets, which are used as nuclei and coated with membrane materials to form microcapsules with a particle size of micrometers. This avoids the defect of low cycle life caused by leakage of phase-change materials during solid-liquid phase transition. However, there is currently no phase-change microcapsule suitable for adding to polyurethane adhesive on the market, because of two reasons. Firstly, phase-change materials are mostly at the micron level, and larger particle sizes are not conducive to dispersion; secondly, available phase-change microcapsules have poor compatibility with the polyurethane body, which leads to a sharp increase in colloid viscosity as the addition amount increases. At the same time, the uniformity of the colloid after dispersion is poor.

### SUMMARY

Based on this, the present disclosure provides a polyurethane phase-change nanocapsule suitable for adding polyurethane adhesive, thereby realizing the application of phase-change materials in phase-change polyurethane pouring sealant.

The technical solutions include the following.

A polyurethane phase-change nanocapsule, formed by coating a phase-change material with an amphiphilic block copolymer, wherein the oleophilic end of the amphiphilic block copolymer is a polyurethane chain segment, and the hydrophilic end of the amphiphilic block copolymer is a methoxy polyethylene glycol chain segment.

In some embodiments, the mass ratio of the polyurethane chain segment to the methoxy polyethylene glycol chain segment is 2 to 3:1.

In some embodiments, the amphiphilic block copolymer is obtained by the reaction of polyurethane and methoxy polyethylene glycol, and the polyurethane is obtained by the reaction of isocyanate and castor oil;

In some embodiments, the mass ratio of isocyanate, castor oil, and methoxy polyethylene glycol is 1:0.3 to 0.4:0.4 to 0.6.

In some embodiments, the isocyanate is diphenylmethane diisocyanate.

In some embodiments, the molecular weight of the methoxy polyethylene glycol is 1800 to 2200.

In some embodiments, the preparation method of the amphiphilic block copolymer includes the following steps:
adding the isocyanate and castor oil to the solvent, heating to re-flux and azeotrope for 4 hours to 8 hours, then adding the methoxy polyethylene glycol, heating to reflux and azeotrope for 4 hours to 8 hours to obtain;

In some embodiments, the solvent is tetrahydrofuran.

In some embodiments, the mass ratio of the isocyanate to the solvent is 1:2 to 3.

In some embodiments, the phase-change material is paraffin and/or stearic acid.

In some embodiments, the polyurethane phase-change nanocapsule is prepared from the amphiphilic block copolymer and the phase-change material in the presence of a crosslinking agent, the feeding mass ratio of the amphiphilic block copolymer to the phase-change material is 1:0.8 to 1.2.

In some embodiments, the crosslinking agent is ethylenediamine.

In some embodiments, the particle size of the polyurethane phase-change nanocapsule is 100 nm to 200 nm.

In some embodiments, the embedding ratio of the phase-change material in the polyurethane phase-change nanocapsule is not less than 75%.

In some embodiments, the embedding ratio of the phase-change material in the polyurethane phase-change nanocapsule is not less than 80%.

The present disclosure also provides a preparation method of the polyurethane phase-change nanocapsule mentioned above.

The technical solutions include the following:

a preparation method of the polyurethane phase-change nanocapsule, including the following steps:
adding the amphiphilic block copolymer and the phase-change material to an organic solvent, mixing and stirring at a reflux temperature for 2 hours to 6 hours, cooling to 20° C. to 35° C., then adding an aqueous solution containing the crosslinking agent under strong stirring conditions at a rotating speed of 1000 rpm to 1400 rpm, and continuing stirring at a rotating speed of 1000 rpm to 1400 rpm for 1 hour to 2 hours to obtain the polyurethane phase-change nanocapsule.

In some embodiments, the organic solvent is ethyl acetate.

In some embodiments, the concentration of the crosslinking agent in the aqueous solution

containing the crosslinking agent is 0.4 mmol/mL to 0.6 mmol/mL.

In some embodiments, the mass ratio of the amphiphilic block copolymer to the organic solvent is 1:1.8 to 2.2; the mass ratio of the organic solvent to the aqueous solution containing the crosslinking agent is 1:8 to 12.

The present disclosure also provides a bi-component phase-change polyurethane pouring sealant with addition of the polyurethane phase-change nanocapsule.

The technical solutions include the following:
a bi-component phase-change polyurethane pouring sealant, including component A and component B, the mixed mass ratio of component A and component B during use is 1 to 5:1, wherein, the component A is prepared from raw materials containing the following components in parts by weight:

| | |
|---|---|
| isocyanates or polyisocyanates | 100 parts |
| thermal conductive filler | 100 parts to 200 parts |
| the polyurethane phase-change nanocapsule | 100 parts to 200 parts |
| the first auxiliary agent | 1 part to 2 parts; |

wherein, the component B is prepared from raw materials containing the following components in parts by weight:

| | |
|---|---|
| polyols | 100 parts |
| catalyst | 0.01 part to 0.05 part |
| thermal conductive filler | 100 parts to 200 parts |
| the polyurethane phase-change nanocapsule | 100 parts to 200 parts |
| the second auxiliary agent. | 0.1 part to 1 part. |

In some embodiments, the mixed mass ratio of the component A and the component B during use is 1 to 2:1.

In some embodiments, the mixed viscosity of the bi-component phase-change polyurethane pouring sealant before curing is 8000 mPa·s to 12000 mPa·s at 25° C.

In some embodiments, the isocyanate or polymeric isocyanate is selected from one or more of TDI, HDI, polymeric MDI, liquefied MDI, and XDI, or is selected from isocyanate terminated prepolymers prepared by reacting one or more of TDI, HDI, polymerized MDI, liquefied MDI, and XDI with polyether, polyester, or plant-based polyol as raw materials.

In some embodiments, the thermal conductive filler is selected from one or more of silicon crystal powder, spherical alumina, aluminum hydroxide, aluminum nitride, boron nitride, and graphene.

In some embodiments, the first auxiliary agent is a dehydrating agent.

In some embodiments, the dehydrating agent is monocyclic oxazolidine or bicyclic oxazolidine.

In some embodiments, the polyol is one or more of polyether polyol, polyester polyol, or plant polyol.

In some embodiments, the plant polyol is castor oil and/or soybean oil modified polyols.

In some embodiments, the viscosity of the polyol at 25° C. ranges from 400 mPa·s to 10000 mPa·s.

In some embodiments, the catalyst is an organic tin catalyst and/or a tertiary amine catalyst.

In some embodiments, the organic tin catalyst is stannous octanoate and/or dibutyltin dilaurate, and the tertiary amine catalyst is triethylenediamine and/or triethanolamine.

In some embodiments, the second auxiliary agent is a leveling agent.

The present disclosure also provides a preparation method of the phase-change polyurethane pouring sealant.

The technical solutions include the following:

a preparation method of the phase-change polyurethane pouring sealant, including the following steps:
preparation of component A: mixing and stirring the isocyanate or polymerized isocyanate, thermal conductive filler, polyurethane phase-change nanocapsule, and the first auxiliary under vacuum at 20° C. to 50° C. for 0.5 hour to 5 hours to obtain component A;
preparation of component B: mixing and stirring the polyol, catalyst, thermal conductive filler, polyurethane phase-change nanocapsule, and second auxiliary under vacuum at 80° C. to 120° C. for 1 hour to 5 hours to obtain component B.

In some embodiments, the vacuum degree of the vacuum stirring is-0.095 MPa to-0.05 MPa.

The present disclosure uses amphiphilic block copolymers constructed from polyurethane chains and methoxy polyethylene glycol segments to prepare polyurethane phase-change nanocapsule coated with phase-change materials through polymer self loading method. This method can accurately control the particle size of the capsules, enrich the preparation technology of phase-change capsules, overcome the incompatibility between existing phase-change microcapsules and polyurethane pouring sealant, and improve the application potential of phase-change capsules in polyurethane pouring sealant.

By adding the polyurethane phase-change nanocapsule coated with phase-change material of the present disclosure, the bi-component phase-change polyurethane pouring sealant obtained by the present disclosure has significant advantages of temperature control compared to traditional polyurethane pouring sealant. It has excellent enthalpy and thermal conductivity while ensuring low viscosity, and has great application value in important electronic engineering fields, especially in high-end electronic fields that require temperature control.

### BRIEF DESCRIPTION OF THE DRAWINGS

FIGURE is the TEM image of polyurethane phase-change nanocapsule.

### DESCRIPTION OF THE EMBODIMENTS

The following will further illustrate the technical solution of the present disclosure through specific embodiments. Technicians in this field should understand that the described embodiments are only intended to assist in understanding the present disclosure and should not be considered as specific limitations to the present disclosure.

Unless otherwise defined, all technical and scientific terms used in the present disclosure have the same meaning as those commonly understood by those skilled in the art to which the present disclosure belongs. The terms used in the description of the present disclosure are for the purpose of describing specific embodiments only and are not intended to limit the present disclosure.

The terms “including” and “having” of the present disclosure, as well as any variations thereof, are intended to cover non exclusive inclusions. For example, a process, method, device, product, or equipment that includes a series of steps is not limited to the listed steps or modules, but optionally includes steps that are not listed, or alternatively includes other steps inherent to these processes, methods, products, or devices.

The term “multiple” mentioned in the present disclosure refers to two or more. “And/or” describes the association relationship of the associated object, indicating that there can be three types of relationships. For example, A and/or B, can represent: the existence of A alone, the coexistence of A and B, and the existence of B alone. The character “/” generally indicates that the associated object is an OR relationship.

The parts involved in the following embodiments and comparative embodiment refer to parts by mass.

Temperature involved in the following embodiments and comparative embodiment was normal room temperature, which is generally within 15° C. to 35° C.

The viscosity of castor oil in the following embodiments and comparative embodiment ranges from 400mPa·s to 600mPa·s; the viscosity described in the present disclosure is the test viscosity at 25° C.

The raw materials or reagents used in the following embodiments and comparative embodiment were all common commercially available products.

The following are specific embodiments.

### Embodiment 1: Preparation of Polyurethane Phase-Change Nanocapsule (A)

Step 1: 100 parts of MDI which is type MDI-100 and produced by Wanhua Chemical Group Co., Ltd., and 35 parts of castor oil were added to 250 parts of tetrahydrofuran, heated to reflux and azeotrope at 80° C., and stirred for 6 hours. Afterwards, 50 parts of methoxy polyethylene glycol (molecular weight of 2000) were added and heated to reflux and azeotrope at 70° C., and stirred for 6 hours. Then the reaction solution was purified through a neutral alumina chromatography column (with tetrahydrofuran as the mobile phase) and a light yellow solid was obtained by rotary evaporation.

The characteristic peaks of the infrared spectrum of the product are as follows: 3312 cm⁻¹ was the absorption peak of N—H, 2876 cm⁻¹ was the stretching vibration peak of —CH₂— in the polyethylene glycol chain, 2273 cm⁻¹ was the asymmetric stretching vibration peak of the isocyanate group NCO, and 1716 cm⁻¹ was the absorption peak of C═O in the amide, 1540 cm⁻¹ was the in-plane bending vibration peak of N—H and the stretching vibration peak in the amide of C—N, 1378 cm⁻¹ was the symmetric vibration peak of CH₃ in the polyethylene glycol chain, 1236 cm⁻¹ was the absorption peak of the amide, and 1115 cm⁻¹ was the symmetric stretching vibration peak of C—O—C in the polyethylene glycol chain.

Step 2: 50 parts of the light yellow solid in Step 1 and 50 parts of paraffin were weighed and added to 100 parts of ethyl acetate, mixed and stirred to reflux at 80° C. for 4 hours. After the mixture cooled to 25° C., 1000 parts of deionized water containing ethylenediamine (concentration of 0.5 mmol/mL) were quickly added under strong mechanical stirring conditions (speed of 1200 rpm). After stirring at a speed of 1200 rpm for half an hour, the mixture turned milky white and the viscosity of the system increased; continue stirring at a speed of 1200 rpm for 1 hour, solid was obtained after filter, then it was washed with deionized water, and vacuum dried at room temperature for 12 hours to obtain white powder, namely polyurethane phase-change nanocapsule.

The product before vacuum drying was dispersed for sample preparation and stained with phosphotungstic acid solution for transmission electron microscopy (TEM) characterization (as shown in FIGURE). It was found that the particle size of the polyurethane phase-change nanocapsule was concentrated between 100 nm to 200 nm.

### Embodiment 2: Preparation of Polyurethane Phase-Change Nanocapsule (B)

Step 1: It is exactly the same as Step 1 in Embodiment 1.

Step 2: 50 parts of the light yellow solid in Step 1 and 50 parts of stearic acid were weighed and added to 100 parts of ethyl acetate, mixed and stirred to reflux at 80° C. for 4 hours. After the mixture cooled to 25° C., 1000 parts of deionized water containing ethylenediamine (concentration of 0.5 mmol/mL) were quickly added under strong mechanical stirring conditions (speed of 1200 rpm). After stirring at a speed of 1200 rpm for half an hour, the mixture turned milky white and the viscosity of the system increased; continue stirring at a speed of 1200 rpm for 1 hour, solid was obtained after filter, then it was washed with deionized water, and vacuum dried at room temperature for 12 hours to obtain white powder, namely polyurethane phase-change nanocapsule(B).

The product before vacuum drying was dispersed for sample preparation and stained with phosphotungstic acid solution for transmission electron microscopy (TEM) characterization. It was found that the particle size of the prepared polyurethane phase-change nanocapsule was consistent with Embodiment 1, concentrated between 100 nm to 200 nm.

### Comparative Embodiment 1: Preparation of Polyurethane Phase-Change Nanocapsule (C)

The difference between the preparation of polyurethane phase-change nanocapsule (C) and Embodiment 1 was replacing the methoxy polyethylene glycol with the corresponding molecular weight of polyethylene glycol, as follows:

Step 1: 100 parts of MDI which is type MDI-100 and produced by Wanhua Chemical Group Co., Ltd., and 35 parts of castor oil were added to 250 parts of polyethylene glycol, heated to reflux and azeotrope at 80° C., and stirred for 6 hours. Afterwards, 50 parts of methoxy polyethylene glycol (molecular weight of 2000) were added and heated to reflux and azeotrope at 70° C., and stirred for 6 hours. Then the reaction solution was purified through a neutral alumina chromatography column (with tetrahydrofuran as the mobile phase) and a light yellow solid was obtained by rotary evaporation.

Step 2: 50 parts of the light yellow solid in Step 1 and 50 parts of paraffin were weighed and added to 100 parts of ethyl acetate, mixed and stirred to reflux at 80° C. for 4 hours. 1000 parts of deionized water containing ethylenediamine (concentration of 0.5 mmol/mL) were quickly added under strong mechanical stirring conditions (speed of 1200 rpm). After stirring for half an hour, the mixture turned milky white and the viscosity of the system increased; continue stirring at a speed of 1200 rpm for 1 hour, solid was obtained after filter, then it was washed with deionized water, and vacuum dried at room temperature for 12 hours to obtain white powder, namely polyurethane phase-change nanocapsule (C).

The product before vacuum drying was dispersed for sample preparation and stained with phosphotungstic acid solution for transmission electron microscopy (TEM) characterization. It was found that the particle size of the polyurethane phase-change nanocapsule was concentrated between 100 nm to 200 nm.

The formation principle and process of polyurethane phase-change nanocapsule in Embodiment 1 and Embodiment 2 are as follows: the block copolymer composed of polyurethane chain and methoxy polyethylene glycol chain prepared in Step 1 can form nanocapsule through self-packaging at the interface of oil-in-water lotion system. The block copolymer itself is an amphiphilic polymer, with the polyurethane chain segment in the oil phase, and the methoxy polyethylene glycol chain in the water phase, so it can be used as a surfactant to stabilize the lotion. Lotion can form nanodroplets under high-speed mechanical agitation, with the droplet interface being a polymer film formed by self-assembly of block copolymer, and the interior of the droplet being an oil phase containing a large number of phase-change materials. In addition, the ethylenediamine crosslinking agent in the aqueous phase can quickly react with the NCO of the polyurethane chain to crosslink and lock the capsule structure, thereby forming a stable polyurethane phase-change nanocapsule that encapsulates phase change materials and with high embedding ratio. In addition, methoxy polyethylene glycol used in the present disclosure contained only one hydroxyl group, so that two NCO groups of MDI only reacted with one hydroxyl group of methoxy polyethylene glycol. The other NCO group reacted with the crosslinking agent ethylenediamine in subsequent Step 2 to form a polyurea bond, which can form a more solid nanocapsule wall, thereby forming stable nanocapsules and further improving the embedding ratio of phase-change materials in polyurethane phase-change nanocapsule.

The embedding ratio of the polyurethane phase-change nanocapsule can be calculated by calculating the amount of paraffin or stearic acid added and the mass of paraffin or stearic acid encapsulated in the dried polyurethane phase-change nanocapsule. In detail, the mass of light yellow solid added before preparing the nanocapsules in Step 2 was weighed, and the white powder after the preparation process in Step 2 was weighed. The mass of the polyurethane phase-change nanocapsule containing paraffin was obtained by subtracting the mass of the white powder from the mass of the light yellow solid, and then dividing it by the total mass of paraffin added in Step 2 to obtain the encapsulation rate of paraffin in the polyurethane phase-change nanocapsule. The results are shown in Table 1. By comparison, it can be seen that the embedding ratio of the polyurethane phase-change nanocapsule prepared in Embodiment 1 and Embodiment 2 was equivalent, which corresponded to the consistent particle size of the two embodiments. Compared with the nanocapsules (C) prepared in Comparative embodiment 1, the embedding ratio of the phase-change materials in Embodiment 1 and Embodiment 2 was significantly higher, due to the polyethylene glycol molecular chain used for the nanocapsule (C) in Comparative embodiment1 has two hydroxyl functional groups, which would consume twice the amount of isocyanate groups than methoxy polyethylene glycol in the process of reaction with isocyanate groups. While the cross-linking density would be reduced and the speed of cross-linking reaction would be slowed down when the subsequent lotion was cross-linked with ethylene diamine (because the isocyanate groups were reduced). So it would lead to the loss of phase-change materials contained in the phase-change nanocapsule during the cross-linking reaction, and the embedding ratio would be significantly reduced.

TABLE 1

| Polyurethane phase-change | embedding ratio of phase-change materials in |
|---|---|
| nanocapsule | polyurethane phase-change nanocapsule (%) |
| Embodiment 1 | 80.0 |
| Embodiment 2 | 80.2 |
| Comparative embodiment 1 | 60.5 |

### Embodiment 3: Preparation of Phase-Change Polyurethane Pouring Sealant I

Component A: 100 parts of polymer MDI which is type PM-200 and produced by Yantai Wanhua Chemical Group Co., Ltd., 150 parts of spherical alumina thermal conductive powder which is type BAK90 and produced by Baitu High tech Materials Technology Co., Ltd., 100 parts of polyurethane phase-change nanocapsule (A) prepared in Embodiment 1, and 1 part of oxazolidine which is type ALT 202 and produced by Anxiang Ailite Chemical Industry Co., Ltd., were added to a planetary machine, and stirred under vacuum for 2 hours at 25° C. under a vacuum degree of −0.09 MPa.

Component B: 50 parts of castor oil, 50 parts of polyether polyol (viscosity 1000-1500 cp) which is type DL3000D and produced by Shandong bluestar Dongda Co., Ltd., 0.01 part of dibutyltin dilaurate as catalyst, 150 parts of spherical alumina thermal conductive powder which is type BAK90 and produced by Baitu High tech Materials Technology Co., Ltd., 100 parts of polyurethane phase-change nanocapsule (A) prepared in Embodiment 1, and 0.5 part of leveling agent which is type BYK370 and produced by Bike Chemical Co., Ltd., were added to the planetary machine, stirred for 2 hours under vacuum degree of −0.09 MPa at 100° C., and then reduced to room temperature and stirred for 2 hours.

### Embodiment 4: Preparation of Phase-Change Polyurethane Pouring Sealant II

Component A: 100 parts of polymer MDI which is type PM-200 and produced by Wanhua Chemical Group Co., Ltd, 150 parts of spherical alumina thermal conductive powder which is type BAK90 and produced by Baitu High tech Materials Technology Co., Ltd., 150 parts of polyurethane phase-change nanocapsule (A) prepared in Embodiment 1, and 1 part of oxazolidine which is type ALT 202 and produced by Anxiang Ailite Chemical Industry Co., Ltd., were added to a planetary machine, and stirred under vacuum for 2 hours at 25° C. under a vacuum degree of −0.09 MPa.

Component B: 50 parts of castor oil, 50 parts of polyether polyol (viscosity of 1000 cp to 1500 cp) which is type DL3000D and produced by Shandong bluestar Dongda Co., Ltd., 0.01 part of dibutyltin dilaurate as catalyst, 150 parts of spherical alumina thermal conductive powder which is type BAK90 and produced by Baitu High tech Materials Technology Co., Ltd., 150 parts of polyurethane phase-change nanocapsule (A) prepared in Embodiment 1, and 0.5 part of leveling agent which is type BYK370 and produced by Bike Chemical Co., Ltd. were added to the planetary machine, stirred for 2 hours under vacuum degree of −0.09 MPa at 100° C., and then reduced to room temperature and stirred for 2 hours.

### Embodiment 5: Preparation of Phase-Change Polyurethane Pouring Sealant III

Component A: 100 parts of polymer MDI which is type PM-200 and produced by Wanhua Chemical Group Co., Ltd., 150 parts of spherical alumina thermal conductive powder which is type BAK90 and produced by Baitu High tech Materials Technology Co., Ltd., 200 parts of polyurethane phase-change nanocapsule (A) prepared in Embodiment 1, and 1 part of oxazolidine which is type ALT 202 produced by Anxiang Ailite Chemical Industry Co., Ltd., were added to a planetary machine, and stirred under vacuum for 2 hours at 25° C. under a vacuum degree of −0.09 MPa.

Component B: 50 parts of castor oil, 50 parts of polyether polyol (viscosity of 1000 cp to 1500 cp) which is type DL3000D and produced by Shandong bluestar Dongda Co., Ltd., 0.01 part of dibutyltin dilaurate as catalyst, 150 parts of spherical alumina thermal conductive powder which is type BAK90 and produced by Baitu High tech Materials Technology Co., Ltd., 200 parts of polyurethane phase-change nanocapsule (A) prepared in Embodiment 1, and 0.5 part of leveling agent which is type BYK370 and produced by Bike Chemical Co., Ltd., were added to the planetary machine, stirred for 2 hours under vacuum degree of −0.09 MPa at 100° C., and then reduced to room temperature and stirred for 2 hours.

### Embodiment 6: Preparation of Phase-Change polyurethane Pouring Sealant IV

Component A: 100 parts of polymer MDI which is type PM-200 and produced by Wanhua Chemical Group Co., Ltd., 150 parts of spherical alumina thermal conductive powder which is type BAK90 and produced by Baitu High tech Materials Technology Co., Ltd., 150 parts of polyurethane phase-change nanocapsule (B) prepared in Embodiment 2, and 1 part of oxazolidine which is type ALT 202 and produced by Anxiang Ailite Chemical Industry Co., Ltd., were added to a planetary machine, and stirred under vacuum for 2 hours at 25° C. under a vacuum degree of −0.09 MPa.

Component B: 50 parts of castor oil, 50 parts of polyether polyol (viscosity of 1000 cp to 1500 cp) which is type DL3000D and produced by Shandong bluestar Dongda Co., Ltd., 0.01 part of dibutyltin dilaurate as catalyst, 150 parts of spherical alumina thermal conductive powder which is type BAK90 and produced by Baitu High tech Materials Technology Co., Ltd., 150 parts of polyurethane phase-change nanocapsule (B) prepared in Embodiment 2, and 0.5 part of leveling agent which is type BYK370 and produced by Bike Chemical Co., Ltd., were added to the planetary machine, stirred for 2 hours under vacuum degree of −0.09 MPa at 100° C., and then reduced to room temperature and stirred for 2 hours.

### Comparative Embodiment 2: Preparation of Phase-Change Polyurethane Pouring Sealant V

Component A: 100 parts of polymer MDI which type PM-200 and produced by Wanhua Chemical Group Co., Ltd., 150 parts of spherical alumina thermal conductive powder which is type BAK90 and produced by Baitu High tech Materials Technology Co., Ltd., 100 parts of phase-change microcapsules (particle size>1 μm) which is type ME-37 and produced by Hubei Thermo New Energy Technology Co., Ltd., and 1 part of oxazolidine which is type ALT 202 and produced by Anxiang Ailite Chemical Industry Co., Ltd., were added to a planetary machine, and stirred under vacuum for 2 hours at 25° C. under a vacuum degree of −0.09 MPa.

Component B: 50 parts of castor oil, 50 parts of polyether polyol (viscosity of 1000 cp to 1500 cp) which is type DL3000D and produced by Shandong bluestar Dongda Co., Ltd., 0.01 part of dibutyltin dilaurate as catalyst, 150 parts of spherical alumina thermal conductive powder which is type BAK90 and produced by Baitu High tech Materials Technology Co., Ltd., 100 parts of phase-change microcapsules (particle size>1 μm) which is type ME-37 and produced by Hubei Thermo New Energy Technology Co., Ltd., and 0.5 part of leveling agent which is type BYK370 and produced by Bike Chemical Co., Ltd., were added to the planetary machine, stirred for 2 hours under vacuum degree of −0.09 MPa at 100° C., and then reduced to room temperature and stirred for 2 hours.

### Comparative Embodiment 3: Preparation of Phase-Change Polyurethane Pouring Sealant VI

Component A: 100 parts of polymer MDI which is type PM-200 and produced by Wanhua Chemical Group Co., Ltd., 150 parts of spherical alumina thermal conductive powder which is type BAK90 and produced by Baitu High tech Materials Technology Co., Ltd., 200 parts of phase-change microcapsules (particle size>1 μm) which is type ME-37 and produced by Hubei Thermo New Energy Technology Co., Ltd., and 1 part of oxazolidine which is type ALT 202 and produced by Anxiang Ailite Chemical Industry Co., Ltd., were added to a planetary machine, and stirred under vacuum for 2 hours at 25° C. under a vacuum degree of −0.09 MPa.

Component B: 50 parts of castor oil, 50 parts of polyether polyol (viscosity of 1000 cp to 1500 cp) which is type DL3000D and produced by Shandong bluestar Dongda Co., Ltd., 0.01 part of dibutyltin dilaurate as catalyst, 150 parts of spherical alumina thermal conductive powder which is type BAK90 and produced by Baitu High tech Materials Technology Co., Ltd., 200 parts of phase-change microcapsules (particle size>1 μm) which is type ME-37 and produced by Hubei Thermo New Energy Technology Co., Ltd., and 0.5 part of leveling agent which is type BYK370 produced by Bike Chemical Co., Ltd., were added to the planetary machine, stirred for 2 hours under vacuum degree of −0.09 MPa at 100° C., and then reduced to room temperature and stirred for 2 hours.

### Comparative Embodiment 4: Preparation of Phase-Change Polyurethane Pouring Sealant VII

Component A: 100 parts of polymer MDI which is type PM-200 produced by Wanhua Chemical Group Co., Ltd., 150 parts of spherical alumina thermal conductive powder which is type BAK90 and produced by Baitu High tech Materials Technology Co., Ltd., 150 parts of polyurethane phase-change nanocapsule (C) prepared in Comparative embodiment 1, and 1 part of oxazolidine which is type ALT 202 produced by Anxiang Ailite Chemical Industry Co., Ltd., were added to a planetary machine, and stirred under vacuum for 2 hours at 25° C. under a vacuum degree of −0.09 MPa.

Component B: 50 parts of castor oil, 50 parts of polyether polyol (viscosity of 1000 cp to 1500 cp) which is type DL3000D and produced by Shandong bluestar Dongda Co., Ltd., 0.01 part of dibutyltin dilaurate as catalyst, 150 parts of spherical alumina thermal conductive powder which is type BAK90 and produced by Baitu High tech Materials Technology Co., Ltd., 150 parts of polyurethane phase-change nanocapsule (C) prepared in Comparative embodiment 1, and 0.5 part of leveling agent which is type BYK370 and produced by Bike Chemical Co., Ltd. were added to the planetary machine, stirred for 2 hours under vacuum degree of −0.09 MPa at 100° C., and then reduced to room temperature and stirred for 2 hours.

The following performance tests were performed on phase-change polyurethane pouring sealant prepared in Embodiment 3 to 6 and Comparative embodiment 2 to 4. Except for the mixed viscosity test, other performance tests were conducted after curing for 72 hours under 25° C. and 50% RH air humidity. The specific methods were as follows:

Test method for mixture adhesion: GB/T 2794-2013 Determination of viscosity of adhesives Single cylinder rotational viscometer method.

Test method for hardness: GB/T 2411-2008 Determination of indentation hardness of plastics and hard rubbers using a hardness tester (Shore hardness).

Test method for thermal conductivity: ASTM D5470-2017 Standard test method for thermal transfer characteristics of thermal insulation materials.

Test method for hot melt enthalpy: Test using a differential scanning calorimeter (DSC) at between 10° C. to 65° C., with a heating rate of 0.1K/min.

Colloidal tensile testing standard: GB/T 1040.2-2006 Determination of tensile properties of plastics Part 2: Testing of molded and extruded plastics.

The test results are shown in Table 2.

TABLE 2

| | The mixed | | Hardness | Thermal | Hot melt | |
|---|---|---|---|---|---|---|
| | mass ratio of | Mixed | after | conductivity | enthalpy | Tensile |
| | Component A | viscosity | curing | coefficient | value | strength |
| Embodiment | and Component B | (mPa · s) | (Shore A) | (W/m · K) | (K · J/g) | (MPa) |
| Embodiment 3 | 1:1 | 8300 | 50 | 0.84 | 101.3 | 3.2 |
| Embodiment 4 | 1:1 | 9400 | 50 | 0.82 | 120.5 | 3.0 |
| Embodiment 5 | 1:1 | 10000 | 52 | 0.82 | 162.2 | 3.0 |
| Embodiment 6 | 1:1 | 9900 | 50 | 0.81 | 160.8 | 2.9 |
| Comparative | 1:1 | 200000 | 50 | 0.79 | 87.7 | 3.3 |
| embodiment 2 | | | | | | |
| Comparative | 1:1 | 280000 | 51 | 0.82 | 95.1 | 3.2 |
| embodiment 3 | | | | | | |
| Comparative | 1:1 | 9600 | 51 | 0.81 | 90.8 | 2.9 |
| embodiment 4 | | | | | | |

Through the comparison of Embodiment 3 to 5, it can be seen that the more amount of polyurethane phase-change nanocapsule loaded with paraffin, the higher the hot melt enthalpy value of the cured pouring sealant, and the viscosity also increased. However, there was no significant difference in hardness and tensile strength, indicating that the amount of polyurethane phase-change nanocapsule added didn't have a significant impact on the mechanical properties of polyurethane pouring sealant; at the same time, the thermal conductivity did not show significant changes due to the thermal conductivity of the polyurethane pouring sealant was mainly affected by the added thermal conductive filler, and the amount of polyurethane phase-change nanocapsule added din't have a significant impact on the thermal conductivity of the polyurethane pouring sealant.

Comparing Embodiment 5 and Embodiment 6, it can be seen that replacing the phase-change material paraffin contained in the polyurethane phase-change nanocapsule with stearic acid does not cause significant changes in various properties.

By comparing Comparative embodiment 2 and Comparative embodiment 3 with the embodiments, it can be seen that adding commercial phase-change microcapsules of the same quality while keeping other formulas unchanged increased the mixed viscosity of polyurethane pouring sealant by more than 20 times. This is because ordinary commercial phase-change microcapsules have poor compatibility with polyurethane colloids themselves, and the capsule particle size was in the micrometer level, which was much larger than the polyurethane phase-change nanocapsule prepared by the present disclosure. As a result, the mixed viscosity of polyurethane pouring sealant was extremely high, and the hot melt enthalpy value was low, indicating that the phase-change effect of polyurethane pouring sealant added with the commercial phase-change microcapsules was poor.

By comparing Comparative embodiment 4 with Embodiment 4, it can be found that although the proportion of phase-change nanocapsule added in Comparative embodiment 4 and Embodiment 4 was the same, the embedding ratio of the phase-change material in the phase-change nanocapsule used in Comparative embodiment 4 was significantly lower than that in

Embodiment 4 (as shown in Table 1). Therefore, the hot melt enthalpy value of the pouring sealant prepared in Comparative embodiment 4 was significantly lower than that in Embodiment 4, indicating its phase-change effect was poor.

The technical features of the embodiments above can be combined arbitrarily. To simplify description, all possible combinations of the technical features of the embodiments above are not described. However, as long as there is no contradiction in the combination of these technical features, they should be considered to be the scope of the specification.

The embodiments above merely express several implementations of the present disclosure. The descriptions of the embodiments are relatively specific and detailed, but may not therefore be construed as the limitation on the patent scope of the present disclosure. It should be noted that a person of ordinary skill in the art may further make several variations and improvements without departing from the concept of the present disclosure. These variations and improvements all fall within the protection scope of the present disclosure. Therefore, the patent protection scope of the present disclosure shall be defined by the appended claims.

What is claimed is:

1. A polyurethane phase-change nanocapsule, formed by coating a phase-change material with an amphiphilic block copolymer, wherein the oleophilic end of the amphiphilic block copolymer is a polyurethane chain segment, and the hydrophilic end of the amphiphilic block copolymer is a methoxy polyethylene glycol chain segment.

2. The polyurethane phase-change nanocapsule according to claim 1, wherein the mass ratio of the polyurethane chain segment to the methoxy polyethylene glycol chain segment is 2 to 3:1.

3. The polyurethane phase-change nanocapsule according to claim 1, wherein the amphiphilic block copolymer is obtained by the reaction of polyurethane and methoxy polyethylene glycol, and the polyurethane is obtained by the reaction of isocyanate and castor oil.

4. The polyurethane phase-change nanocapsule according to claim 3, wherein the mass ratio of isocyanate, castor oil, and methoxy polyethylene glycol is 1:0.3 to 0.4:0.4 to 0.6.

5. The polyurethane phase-change nanocapsule according to claim 3, wherein the isocyanate is diphenylmethane diisocyanate.

6. The polyurethane phase-change nanocapsule according to claim 3, wherein the molecular weight of the methoxy polyethylene glycol is 1800 to 2200.

7. The polyurethane phase-change nanocapsule according to claim 3, wherein the preparation method of the amphiphilic block copolymer comprises the following steps:
adding the isocyanate and castor oil to the solvent, heating to re-flux and azeotrope for 4 to 8 hours, then adding the methoxy polyethylene glycol, heating to reflux and azeotrope for 4 to 8 hours to obtain.

8. The polyurethane phase-change nanocapsule according to claim 7, wherein the solvent is tetrahydrofuran.

9. The polyurethane phase-change nanocapsule according to claim 7, wherein the mass ratio of the isocyanate to the solvent is 1:2 to 3.

10. The polyurethane phase-change nanocapsule according to claim 1, wherein the polyurethane phase-change nanocapsule is prepared from the amphiphilic block copolymer and the phase-change material in the presence of a crosslinking agent, the feeding mass ratio of the amphiphilic block copolymer to the phase-change material is 1:0.8 to 1.2.

11. The polyurethane phase-change nanocapsule according to claim 10, the crosslinking agent is ethylenediamine.

12. The polyurethane phase-change nanocapsule according to claim 1, wherein the phase-change material is paraffin and/or stearic acid; and/or
the particle size of the polyurethane phase-change nanocapsule is 100 nm to 200 nm; and/or
the embedding ratio of the phase-change material in the polyurethane phase-change nanocapsule is not less than 75%.

13. The polyurethane phase-change nanocapsule according to claim 12, wherein the embedding ratio of the phase-change material in the polyurethane phase-change nanocapsule is not less than 80%.

14. A preparation method of the polyurethane phase-change nanocapsule according to claim 1, comprising the following steps:
adding the amphiphilic block copolymer and the phase-change material to an organic solvent, mixing and stirring at a reflux temperature for 2 hours to 6 hours, cooling to 20° C. to 35° C., then adding an aqueous solution containing the crosslinking agent under strong stirring conditions at a rotating speed of 1000 rpm to 1400 rpm, and continuing stirring at a rotating speed of 1000 rpm to 1400 rpm for 1 hour to 2 hours to obtain the polyurethane phase-change nanocapsule.

15. The preparation method of the polyurethane phase-change nanocapsule according to claim 14, wherein the organic solvent is ethyl acetate.

16. The preparation method of the polyurethane phase-change nanocapsule according to claim 14, wherein the concentration of the crosslinking agent in the aqueous solution containing the crosslinking agent is 0.4 mmol/mL to 0.6 mmol/mL.

17. The preparation method of the polyurethane phase-change nanocapsule according to claim 14, wherein the mass ratio of the amphiphilic block copolymer to the organic solvent is 1:1.8 to 2.2; the mass ratio of the organic solvent to the aqueous solution containing the crosslinking agent is 1:8 to 12.

18. A phase-change polyurethane pouring sealant, comprising component A and component B, wherein the mixed mass ratio of component A and component B during use is 1 to 5:1,
wherein, the component A is prepared from raw materials containing the following components in parts by weight:

| | |
|---|---|
| isocyanates or polyisocyanates | 100 parts |
| thermal conductive filler | 100 parts to 200 parts |
| the polyurethane phase-change nanocapsule | 100 parts to 200 parts |
| according to claim 1 | |
| the first auxiliary agent | 1 part to 2 parts; |

wherein, the component B is prepared from raw materials containing the following components in parts by weight:

| | |
|---|---|
| polyols | 100 parts |
| catalyst | 0.01 part to 0.05 part |
| thermal conductive filler | 100 parts to 200 parts |
| the polyurethane phase-change nanocapsule | 100 parts to 200 parts |
| according to claim 1 | |
| the second auxiliary agent | 0.1 part to 1 part. |

19. The phase-change polyurethane pouring sealant according to claim 18, wherein the mixed mass ratio of the component A and the component B during use is 1 to 2:1; and/or,
the mixed viscosity of the phase-change polyurethane pouring sealant before curing is 8000 mPa·s to 12000 mPa·s at 25° C.; and/or
the isocyanate or polymeric isocyanate is selected from one or more of TDI, HDI, polymeric MDI, liquefied MDI, and XDI, or is selected from isocyanate terminated prepolymers prepared by reacting one or more selected from TDI, HDI, polymerized MDI, liquefied MDI, and XDI with polyether, polyester, or plant-based polyol as raw materials; and/or
the thermal conductive filler is selected from one or more of silicon crystal powder, spherical alumina, aluminum hydroxide, aluminum nitride, boron nitride, and graphene; and/or
the first auxiliary agent is a dehydrating agent; and/or
the polyol is one or more of polyether polyol, polyester polyol, or plant polyol; and/or
the viscosity of the polyol at 25° C. ranges from 400 mPa·s to 10000 mPa·s; and/or
the catalyst is an organic tin catalyst and/or a tertiary amine catalyst, wherein the organic tin catalyst is stannous octanoate and/or dibutyltin dilaurate, and the tertiary amine catalyst is triethylenediamine and/or triethanolamine; and/or
the second auxiliary agent is a leveling agent.

20. A preparation method of the phase-change polyurethane pouring sealant according to claim 18, comprising the following steps:
preparation of component A: mixing and stirring the isocyanate or polymerized isocyanate, thermal conductive filler, polyurethane phase-change nanocapsule, and the first auxiliary under vacuum at 20° C. to 50° C. for 0.5 hour to 5 hours to obtain;
preparation of component B: mixing and stirring the polyol, catalyst, thermal conductive filler, polyurethane phase-change nanocapsule, and second auxiliary under vacuum at 80° C. to 120° C. for 1 hour to 5 hours to obtain.
